(19) United States
(12) Patent Application Publication
(10) Pub. No.: US 2025/0371652 A1
(43) Pub. Date: Dec. 4, 2025

(54) STRUCTURAL IMAGE MARKING TECHNIQUES FOR INFORMATION SECURITY AND SOURCE DETECTION

(71) Applicant: EchoMark, Inc., Kirkland, WA (US)

(72) Inventors: Sanjay KRISHNAN, Hinsdale, IL (US); David WONG, Los Gatos, CA (US)

(21) Appl. No.: 18/680,538

(22) Filed: May 31, 2024

(51) Int. Cl. G06T 3/18; G06T 5/70; G06T 7/13; G06V 10/44

(52) U.S. Cl. CPC G06T 3/18; G06T 5/70; G06T 7/13; G06V 10/44

(57) ABSTRACT

Information security is enhanced through watermarks that are unique for each recipient. Unique watermarking helps deter malicious information leaks because of the likelihood that the leaked information can be traced back to the source. To watermark images in a unique way for each recipient, candidate control points are determined for locations of image features within an image. The candidate control points that correspond to copy-resilient image features are identified. For generating each unique copy, a set of control points is selected from the candidate control points for the copy-resilient image features. An image is warped based on the selected set of control points. Since each set of control points is different, each warped image is distinct. The sets of control points can be saved and later used to recreate unique copies that are compared to recovered artifacts for source identification.

### BACKGROUND

Protecting company information and intellectual property is crucial, as it helps maintain a company's competitive advantages and helps to ensure regulatory compliance. Source detection of leaked information helps prevent losses and reputational damage by deterring breaches and identifying sources so that action can be taken if necessary. Watermarking techniques can be used to enhance information security. Many of these techniques embed unique, invisible identifiers into documents and media that help trace the origin of leaks when they occur. Watermarking techniques can help deter unauthorized sharing and aid in enforcing data security policies by linking content back to the source.

### SUMMARY

At a high level, aspects of the present disclosure relate to structurally warping images for document security and source detection. To protect information and identify sources of leaked information, an image can be warped so that there are subtle but distinct differences between different warped images. Each warped image can be provided to a different recipient. If an image artifact of a warped image is recovered, such as a leaked copy of the warped image, the artifact can be used to identify the warped image from which it was derived. In doing so, the artifact can be used to identify potential sources of the leak.

Warping an image is a structural transformation that dilates and contracts different parts of an image. The locations of these dilations and contractions are determined by selected control points, or pixel indexes, in an image. A set of candidate control points may be selected to correspond to features within the images, such as corners, lines, or other important or prominent visual features in the image. A portion of the candidate control points that correspond to copy-resilient image features-the features that are more likely than others to appear in reduced-quality or grayscale copies-are selected.

A warped image can be generated from control points that are from the selected portion of candidate control points for the copy-resilient image features. Thus, a distinct warped image can be created by warping the image using a different set of control points that has been determined from the selected portion of candidate control points. In some cases, the control points are randomly selected from the candidate control point, although other selection algorithms and methodologies may be employed. The warping can be done by modifying the image based on relative pixel proximity to a control point. As such, when different control points are used, each image has a subtle, but detectable, warping that is different from other warped images. The warped images can be provided to different recipients.

If an image artifact is recovered, the image artifact can be compared to the warped images to determine the warped image from which it was derived. In doing so, a source index can be referenced to identify the locations of the control points for various recipients. The control points can be used to recreate warped images that are compared to the artifact. A statistical analysis can be performed to determine the likelihood that the artifact was derived from one of the warped images, thus identifying the potential source as the recipient of the warped image from which the artifact was derived.

This summary is intended to introduce a selection of concepts in a simplified form that is further described in the detailed description section of this disclosure. The summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 illustrates an example operating environment in which aspects of the technology may be employed, in accordance with an aspect described herein;

FIG. 2 illustrates an example image warping to generate distinct warped images that can be provided to recipients for information source detection, in accordance with an aspect described herein;

FIG. 3 illustrates an example identification of candidate control points within an image, in accordance with an aspect described herein;

FIG. 4A illustrates an example pixel contrast for determining copy-resilient image features, in accordance with an aspect described herein;

FIG. 4B illustrates an example feature determination from blurred images for determining copy-resilient image features, in accordance with an aspect described herein;

FIG. 5 illustrates an example determination of copy-resilient image features from an image, in accordance with an aspect described herein;

FIG. 6 illustrates an example in which control points are determined from candidate control points of an image, in accordance with an aspect described herein;

FIG. 7A illustrates example images warping using sets of control points to generate distinct warped images for information source detection, in accordance with an aspect described herein;

FIG. 7B illustrates one of the example warped images warped at FIG. 7A, in accordance with an aspect described herein;

FIG. 8 illustrates an example in which a source of an image artifact is determined, in accordance with an aspect described herein;

FIG. 9 illustrates an example image warping for determining a source of an image artifact, in accordance with an aspect described herein;

FIG. 10 illustrates an example keypoint identification and matching for determining a source of an image artifact, in accordance with an aspect described herein;

FIG. 11 illustrates an example source determination from matching keypoints, in accordance with an aspect described herein;

FIG. 12 illustrates a flow diagram of an example method for image warping for information source detection, in accordance with an aspect described herein;

FIG. 13 illustrates a flow diagram of an example method for images warping and control point indexing for information source detection, in accordance with an aspect described herein;

FIG. 14 illustrates a flow diagram of an example method for generating distinct warped images based on a number of electronic addresses received in an electronic communication, in accordance with an aspect described herein;

FIG. 15 illustrates a flow diagram of an example image matching for determining a source of an image artifact, in accordance with an aspect described herein; and

FIG. 16 illustrates an example computing device suitable for implementing aspects of the technology, in accordance with an aspect described herein.

### DETAILED DESCRIPTION

Information source detection plays a crucial role in information security, serving as a method to trace the origin and authenticity of information. Source detection techniques help ensure the integrity and confidentiality of information in a digital landscape where data breaches and unauthorized distribution present ever-increasing risks to organizations. Essentially, information source detection involves embedding identifiable features or modifying attributes of text, images, and media files, such that their sources can be verified or traced if an artifact of leaked information is recovered.

Historically, various methods have been employed for source detection. One of the early methods is watermarking, which can be applied to both text and images. For text documents, watermarking often involves embedding a code or pattern into the text that is not readily visible during normal viewing but can be detected using specialized software. Similarly, image watermarking might involve overlaying text or a logo directly onto the image or embedding a digital watermark that alters the image on a pixel level, which is imperceptible to the naked eye but detectable with the right tools.

While effective to some extent, these techniques come with challenges. For example, watermarks that overlay text on images can obscure important visual content, reducing the usability of the image. Furthermore, such watermarks can often be detected and removed using fairly general image processing software. Digital watermarks that alter pixel data are less intrusive visually but still face challenges, particularly when images are manipulated or edited, or when the reproduction is of poor quality or only a partial reproduction, since these changes can disrupt the embedded watermark.

Resilient digital watermarks, also called forensic watermarks, can also be employed for images and video. These watermarks are designed to be imperceptible and resilient to evasion strategies like downsampling, cropping, and aspect ratio changes. The most popular forensic watermarking algorithms leverage spectral techniques for watermarking. These algorithms overlay subtle color and intensity patterns that are generally imperceptible to the human eye but detectable via algorithmic analysis. While highly useful for digital media applications where the primary leak modality is digital reproduction, i.e., an extraction and copy of a media file, these algorithms have degraded accuracy when information is leaked through a modality where color and intensity information is distorted. For example, a photograph of a screen is sensitive to the lighting and camera flash settings. Or, a laser printer printout of an image might change the apparent colors compared to a digital rendering.

Another technique involves the use of metadata within media files. Metadata can store information about the file's origin, author, creation date, and more. However, this method relies heavily on the availability of the original file itself or a complete reproduction of it. If a user simply shares a screenshot or a photocopy of an image, the metadata might not transfer. Moreover, metadata can be easily stripped from files using metadata scrubbers, which are widely available and simple to use. This makes reliance on metadata alone somewhat unreliable for document source detection.

Many of these existing methods break down when documents and images undergo significant alterations, such as changes in format, compression, or quality, or when they are reproduced using certain methods like photographing a printed image, screenshotting an image, or the like. These reproduction methods often create low-quality reproductions that distort the embedded watermarks, or alter or remove the metadata, leading to a failure in source detection.

Additionally, methods that require maintaining unique copies of each document variant for verification purposes lead to substantial storage demands, which might be impractical for organizations handling large volumes of data. This storage issue, coupled with the potential for easy manipulation and loss of embedded information, underscores the necessity for more robust and adaptable source detection methodologies, particularly those methodologies that are robust to low-quality reproductions and those that reduce storage demand, while still providing a high degree of certainty when identifying a source from a recovered artifact.

The technology described in the present disclosure helps overcome many of these challenges, particularly with those related to watermarking images for source detection. As described, many of the existing image watermarking techniques are susceptible to failure when there are low-quality reproductions, and they may require exceptional storage demands due to the nature of media files.

To help solve these issues, the present disclosure describes techniques for structurally watermarking images. A structural watermark selectively dilates and contracts different parts of an image. Dilation is when the apparent distance between pixels is increased, and contraction is where it is decreased. The overall pattern of dilation and contractions is called a warping. Images can be warped to create a unique copy for each recipient, while still maintaining image quality with little disruption to the image content itself. Thus, uniquely identifying a structural watermark does not require high-quality pixel color or intensity information, but rather may only identify the pattern of relative distances between pixels.

The warping is generated according to certain identified points on the images, called control points. For instance, a contraction can be applied where pixels closer to a control point are warped to a greater degree relative to pixels farther from the control point. Thus, by varying the locations of the control points, different unique copies of an image can be created having a different warping patterns. The effect can be applied across the image, thus allowing for source detection when there is only a partial reproduction of a unique copy.

Control points can be selected from candidate control points identified in an image. As such, different unique copies of an original image can be created using different sets of selected control points. The candidate control points can be identified at locations corresponding to features within the images. Since some image features are more resilient to reproduction at low qualities, aspects of the technology select candidate control points that correspond to copy-resilient image features. These features may be identified based on their pixel contrast or visual prominence when the image is blurred. Thus, some techniques may select candidate control points from those that correspond to copy-resilient image features. An image is then warped using a selected set of control points from the candidate control points. This may be done for each recipient, who is then provided a unique copy of the image having a different warping.

In aspects, control points can be further be chosen to minimize the apparent distortion, caused by the warping, to a human observer. For example, control points may be selected in a way to minimize dilation and contraction around high-contrast edges and corners. In aspects, control points can be selected so that straight lines and the alignment of text fragments is minimally distorted. Such heuristics can be applied to filter the set of the candidate control points when selecting control points used for warping.

If an artifact of a unique copy is recovered, the artifact can be used to determine the unique copy from which it was derived, thus identifying a potential source of the leak. To do so, the artifact can be compared to unique copies, and a statistical analysis can be applied, such as a Pearson correlation, to determine the likelihood that the artifact was derived from a particular unique copy.

For the comparison, unique copies can be generated from stored sets of control points from a source index. Each set of control points can be used to warp an image in a manner consistent with the image warping when generating the unique copies for distribution, such as using the same image's warping algorithm. To do the matching, a correspondence between pixels in the artifact and each of the unique copies is established. Such a correspondence can be found with a variety of image feature matching algorithms that identify and match keypoints between the artifact and the unique copies. The statistical analysis is then performed over the corresponding pixels. The statistical analysis identifies from which unique copy the artifact was likely derived, namely, whether the relative distances between matching pixels in the artifact are consistent with the warping pattern in the copy. The source having received that particular unique copy may be identified as the possible source of the leak.

The technology described in this disclosure for watermarking images improves upon existing methods. For instance, the present technology is better suited for matching unique copies to low-quality reproduction artifact. This may stem from the identification and use of robust points in the image that are likely to appear in lower-quality reproductions when warping and matching the images. Further still, aspects of the technology may use a warping algorithm with a decay function that helps ensure warping patterns are available for detection, even in partially reproduced artifacts. Similarly, the use of random candidate control points across the images also increases the likelihood that a location within an image corresponding to a control point is included in a partially reproduced artifact.

Moreover, the images may be warped in a manner, such as using the decay function, that helps reduce distortion in the image relative to existing methods, especially those using printed text to watermark an image. Additionally, whereas watermarking methods using printed text may be susceptible to someone removing the text, warping an image according to a randomly selected set of control points reduces the likelihood that someone will be able to remove the watermarking, since an algorithm to detect warping patterns and remove these patterns would be substantially more complex and would likely require significant customization.

Yet another benefit provided by the presently disclosed technology is reduced storage space. As noted, some prior methods store unique copies for later comparison. When storing images, the storage requirements can exponentially increase as the number of recipients grows. However, the present methods allow for recreation of a unique copy of a stored set of control points. The storage space required to store a string of data identifying the locations of control points is negligible compared to the storage requirements of an image. Thus, the present technology requires far greater computer storage demands compared to existing methods.

It will be realized that the methods previously described are only examples that can be practiced from the description that follows, and the examples are provided to more easily understand the technology and recognize its benefits. Additional examples are now described with reference to the figures.

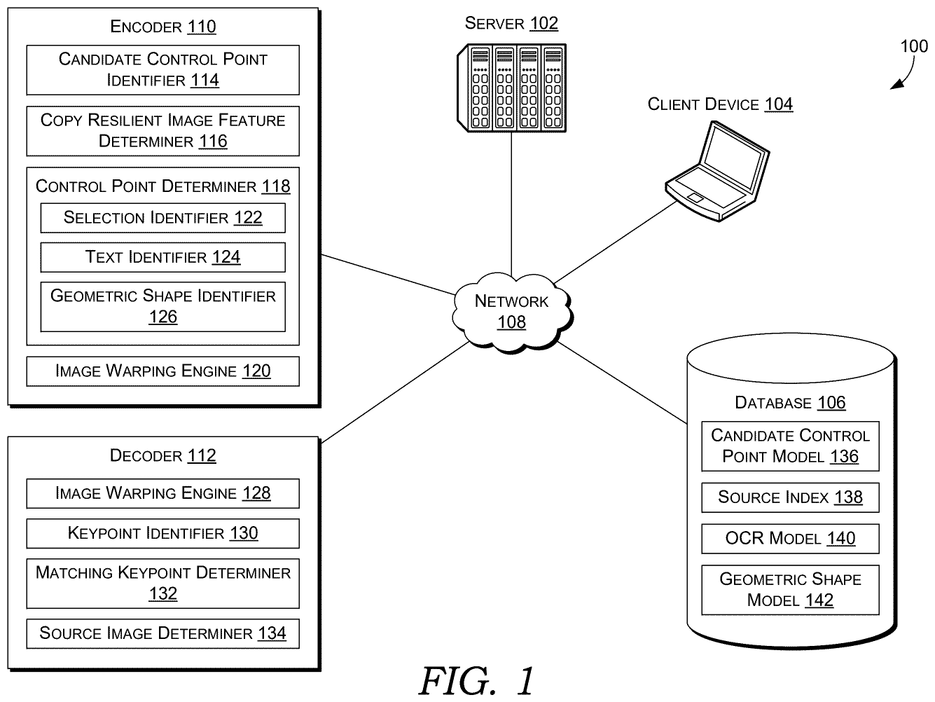

FIG. 1 presents an example operating environment 100 suitable for implementing aspects of the technology, such as watermarking images in a distinct manner and identifying a particular unique copy from a recovered artifact using the distinct watermarks. At a high level, the example illustrated uses encoder 110 to generate distinct warped copies of images that can be used for source identification by decoder 112.

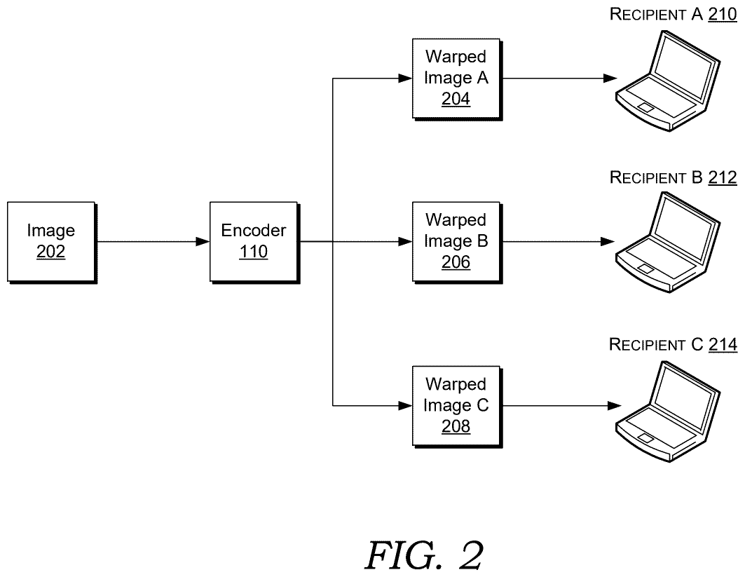

In an example aspect, client device 104 can be used to provide an image. From the image, server 102, employing encoder 110, can be used to generate a number of warped images that are each distinct from one another. In aspect, an image may be a stand-alone image or may be a frame from a video. With reference also to FIG. 2, FIG. 2 illustrates an example in which encoder 110 is used to generate distinct warped images of image 202. Here, encoder 110 receives image 202 and from it generates a plurality of warped images, where each image is distinct from one another. This includes warped image A 204, warped image B 206, and warped image C 208. While illustrated as three warped images, the plurality of warped images generated by encoder 110 may be any number. In aspects, the number of warped images being generated may correspond to a number of intended recipients so that each recipient receives a warped image that is distinct from other warped images received by other recipients. This allows particular recipient to be identified should a leak of the information occur. In operating environment 100, warped image A 204 is provided to recipient A 210. Warped image B 206 is provided to recipient B 212. Warped image C 208 is provided to recipient C 214. Each distinct warped image generated by encoder 110 can be respectively provided to a recipient. In this example, encoder 110 generates distinct warped images for recipients using candidate control point identifier 114, copy-resilient image feature determiner 116, control point determiner 118, and image warping engine 120.

As a general matter, a native image may have various file formats. Some examples include JPEG (Joint Photographic Experts Group), PNG (Portable Network Graphics), TIFF (Tagged Image File Format), GIF (Graphics Interchange Format), BMP (Bitmap Image File), HEIF (High-Efficiency Image File Format), SVG (Scalable Vector Graphics), and EPS (Encapsulated PostScript), among others. In some cases, images may be included within various files and embedded within documents rendered therefrom, such as those for slide presentations, word processors, PDF (Portable Document Format) files, or other application files. It will be appreciated that some native images may be raster images, while others may be provided in non-raster, or vector, formats.

To generate a distinct warped image, encoder 110 may identify whether the image is a raster image or non-raster image. For instinct, this may be done based on the file type including the image. In aspects, non-raster images may be converted to raster images, i.e., a bitmap. For instance, each pixel in a bitmap image is given a specific position and color value, which collectively form the complete image. Bitmap images can be stored in pixel-based formats that are defined by their width and height in pixels. They may also be defined in terms of their depth (color resolution), which determines how many colors each pixel can represent. Various known tools allow conversion of a non-raster image to a bitmap.

Candidate control point identifier 114 may be used to identify candidate control points within an image, such as the bitmap image. Candidate control point identifier 114 may do so by employing candidate control point model 136 to identify features within an image, which can be associated with candidate control points. In general, a control point, as will be described, may be a location within an image that is used to warp the image, giving the image a particular warping pattern according to the location of the control point or plurality of control points. Candidate control points are identified locations that are candidates for being selected as control points that are used to warp the images.

In aspect, the locations at which candidate control points are identified may correspond to image features within an image. Broadly, an image feature may be a distinct and recognizable part of an image, such as an edge, corner, or texture pattern, that can be used for analysis, recognition, or interpretation by computer vision systems. For instance, an image feature may be a pattern formed by a series of pixels within the images, such as a delineation between intensity or color across multiple pixels. In aspects, image features may be detected and described by algorithms to facilitate tasks like image matching, recognition, and reconstruction.

Candidate control point model 136 may be a model that identifies features within an image. The model may be a machine learned model or another type of model for detecting image features. To provide an example, a feature detection model may use deep learning techniques. A specific approach is to use a convolutional neural network (CNN) to learn feature detection. For instance, a pre-trained CNN backbone, like ResNet (Residual Network), may be used to extract hierarchical features from the input images. The model may be trained to detect image features using a dataset that includes images with annotated features and descriptors. One example may be the HPatches dataset, which includes pairs of images with known homographies. Other models, training techniques, and training sets may be used for identifying image features or specific image features. This is one example intended to aid in describing the technology. In another example, SIFT (scale-invariant feature transform) or a SIFT-type algorithm may be used and candidate control points can be ranked by their SIFT response scores.

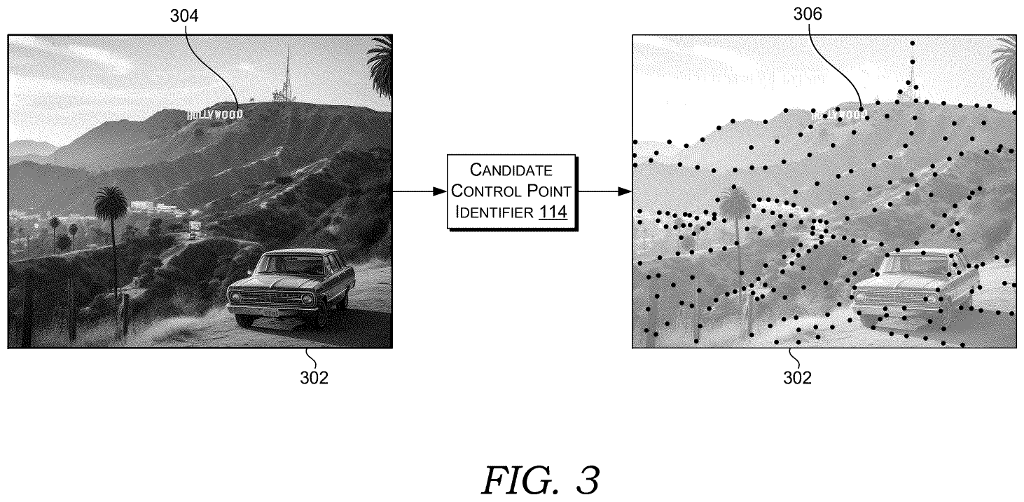

FIG. 3 provides an illustrated example of candidate control point identifier 114 identifying candidate control points using features identified by candidate control point model 136. An example image feature 304 is illustrated with respect to image 302. Candidate control point model 136 may be used to identify image features generally within image 302. The identified features can be associated with candidate control points. Here, identified image features have provided, as locations for the candidate control points, output from candidate control point identifier 114. In the illustration, candidate control point 306 has been identified as a candidate control point corresponding to the location of image feature 304, which is provided as an example among many to help illustrate and describe the technology. It will be realized that the annotations within image 302 illustrate a sampling of candidate control points, and that many additional image features and the corresponding candidate control points may be identified within image 302. For clarity of the drawings, only one annotation has been labeled, illustrated as candidate control point 306, although other candidate control points are shown. Any number of features and candidate control points may be identified using candidate control point identifier 114.

In some aspects, candidate control points may be further selected based on whether the candidate control points correspond to copy-resilient image features. In general, feature resiliency refers to the ability of a feature within an image to maintain its integrity, clarity, or legibility even after being reproduced or copied one or more times. It implies that the feature of the copy remains recognizable despite the potential degradation that can occur during the copying process. Thus, a copy-resilient feature generally describes an image feature that demonstrates the ability to maintain its clarity, integrity, or legibility across copies. Said another way, it's a characteristic of the original content that remains identifiable across copies, including low-quality copies, highlighting its resilience to degradation during the copying process.

Feature resiliency can be objectively measured by copy-resilient image feature determiner 116 using some image analysis techniques. For instance, pixel contrast and image blur may be used to determine a level of copy resiliency, i.e., feature resiliency, of a feature for determining copy-resilient image features.

For instance, copy-resilient image feature determiner 116 may determine a level of pixel contrast between two or more pixels in an area of the image corresponding to a feature. In general, the greater the contrast, the more likely the feature is to appear in low-quality reproductions, making the feature relatively more copy resilient. That is, the relatively greater the pixel contrast, the greater the copy resiliency. Pixel contrast may refer to the quantifiable degree of difference between two or more pixels, and may refer to a difference in intensity, color, or other like pixel values.

In an aspect, pixel contrast is determined for a pixel neighborhood corresponding to an image feature. The pixel neighborhood may include pixels forming the feature and pixels immediately surrounding the image feature. A threshold pixel neighborhood size value may be applied to determine the size of the pixel neighborhood surrounding an image feature, such as a pixel radius from a pixel central to the image feature. An additive, average, or other like measurement quantifying the degree of difference between pixels in the pixel neighborhood may be used to determine pixel contrast.

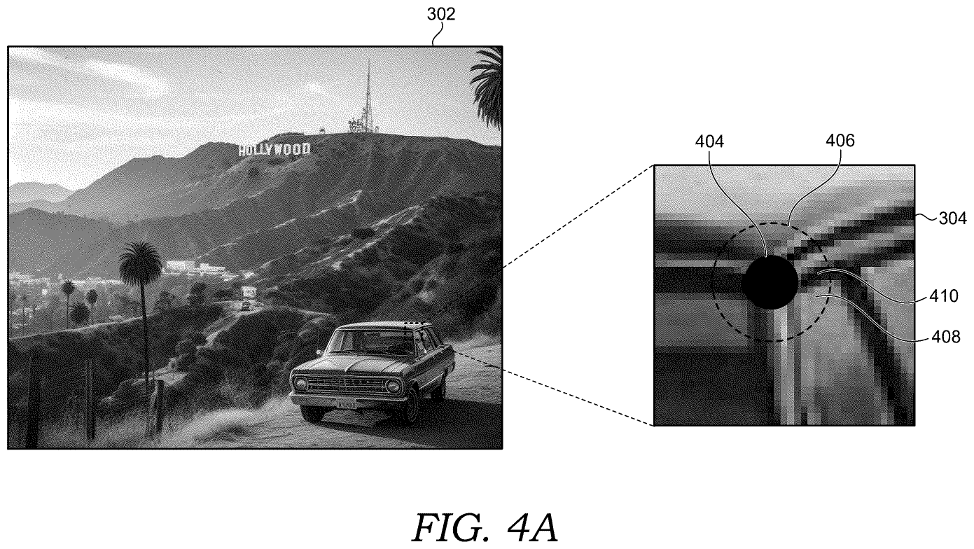

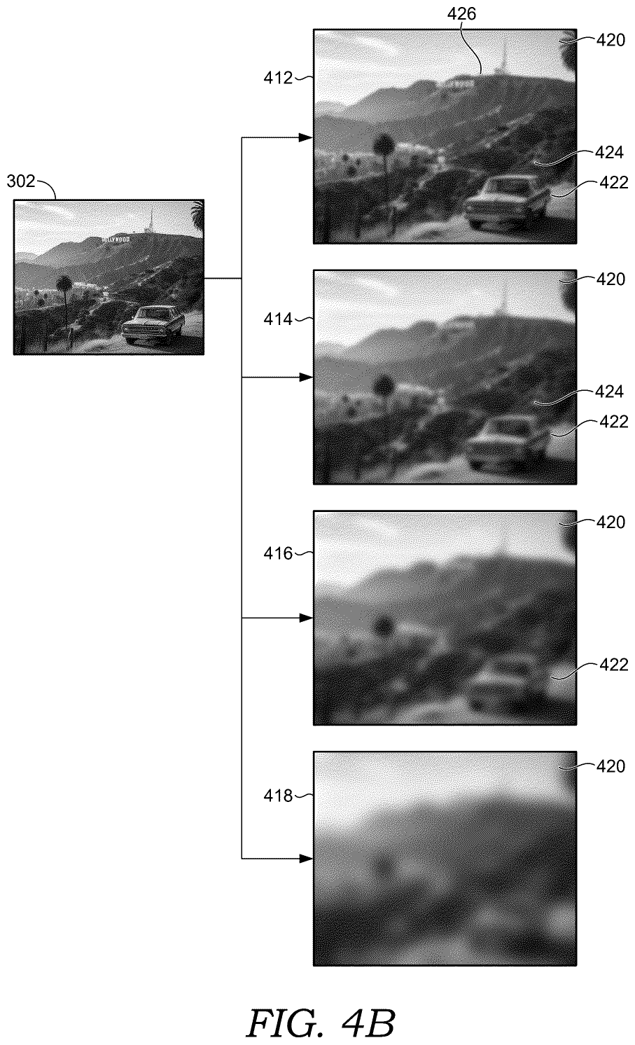

FIG. 4A provides an illustrated example. Here, image feature 304 has been expanded from image 302. In this example, image feature 304 has been identified as a feature, and thus, a corresponding candidate control point 404 has been determined at the location of the image feature. Pixel neighborhood 406 represents pixels immediately surrounding candidate control point 404 and includes pixel A 408 and pixel B 410. As noted, the contrast between the pixels within pixel neighborhood 406, such as pixel A 408 and pixel B 410, can be quantified.

A threshold level of pixel contrast may be used to determine which image features are copy-resilient image features, for example. As an example, each of the candidate control points for an image may be quantified according to the pixel contrast. A threshold value may be used to select a top percentage of these features as copy-resilient image features. In another example, a threshold image feature contrast value is determined. These values may be used alone or in combination with others when selecting features that are copy-resilient image features, and thus determining whether a candidate control point corresponds to a copy-resilient image feature.

Copy-resilient image feature determiner 116 may apply other methods as well. For example, simulation studies assess how features withstand copying under various conditions. One such method blurs an image having identified candidate control points corresponding to various feature locations with the image. In doing so, an image may be blurred one or more times. Features appearing in both the image and the blurred image may be relatively more copy-resilient relative to features appearing in the image but not in the blurred image. A level of copy resiliency may be determined based on the amount of blur applied to an image, meaning that features appearing in images to which a relatively greater degree of blur is applied are more copy resilient than those features that become obscured at low levels of blur. Image blur may be applied using any known methods, including general image editing software functions that can apply image blur at desired levels.

FIG. 4B depicts an example in which copy resiliency of various features is determined using blur techniques. Image blur is applied to image 302 at variable intensities to generate blurred image A 412, blurred image B 414, blurred image C 416, and blurred image D 418. While shown as four blurred images, any one or more blurred images may be generated when determining copy-resilient image features. In the illustrated example, image feature A 420, image feature B 422, image feature C 424, and image feature D 426 all appear in blurred image A 412, which has a 5% blur applied. However, only image feature A 420, image feature B 422, and image feature C 424 appear in blurred image B 414, which has a 10% blur applied. This indicates that each of these features is more resilient to copying than image feature D 426. This continues, as only image feature A 420 and image feature B 422 appear in blurred image C 416, which has a 20% blur applied. Finally, image feature A 420 is the only image feature that appears in blurred image D 418, where a 40% blur has been applied. It will be realized that other features appear across the blurred images; however, only a select few have been indicated in the figures for clarity to aid in describing the technology.

Other techniques may be applied to quantitatively or qualitatively measure image resiliency for determining copy-resilient image features, and those candidate control points that correspond to copy-resilient image features, in addition to or in lieu of those described. For instance, statistical metrics such as signal-to-noise ratio and contrast-to-noise ratio may also provide an indication of a feature's copy resiliency across reproductions.

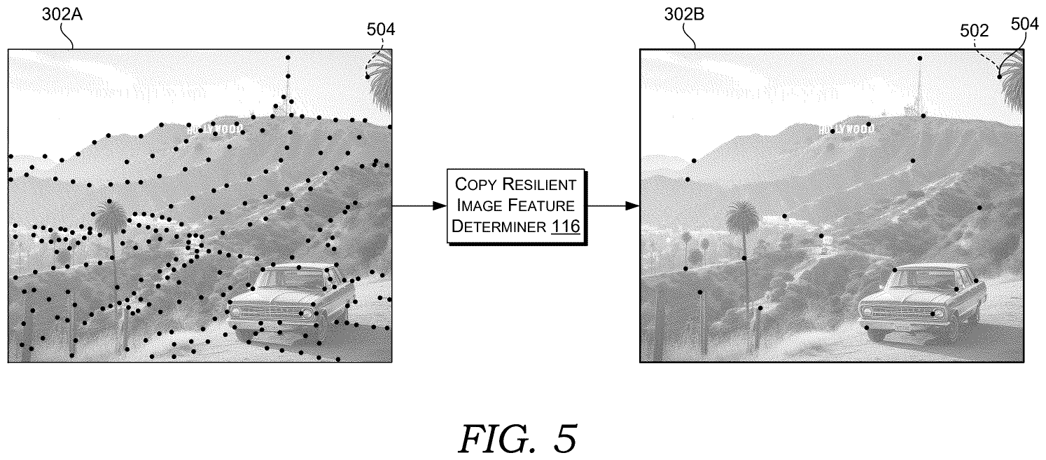

FIG. 5 is an example illustration depicting candidate control points corresponding to copy-resilient image features determined by copy-resilient image feature determiner 116. In this example, image 302A and image 302B each corresponds to image 302. As shown in FIG. 5, image 302A is illustrated having candidate control points that correspond to image features, some of which are copy-resilient image features. As described, copy-resilient image feature determiner 116 can be used to determine copy-resilient image features within image 302A. Accordingly, image 302B depicts candidate control points that correspond to copy-resilient image features determined by copy-resilient image feature determiner 116. In the example, candidate control points that correspond to image features that are not copy resilient according to copy-resilient image feature determiner 116 have been removed, illustrating only those candidate control points corresponding to copy-resilient image features. While there are multiple candidate control points annotated in image 302B, one example is labeled for illustrative purposes. Here, image 302B includes copy-resilient image feature 502, which happens to be a relatively high-contrast pixel area in this particular example. The candidate control point 504 corresponding to the location of copy-resilient image feature 502 is also illustrated in 302B. Thus, as noted, some aspects of the technology select a portion of the candidate control points corresponding to copy-resilient image features. In such aspects, control point determiner 118 may determine a set of control points, which is used to warp an image, from the candidate control points corresponding to copy-resilient image features, as will be further described.

Control point determiner 118 generally determines control points from candidate control points. The control points determined by control point determiner 118 may be used for image warping to general distinct warped images. Control point determiner 118 determines control points for image warping from the candidate control points identified by candidate control point identifier 114. In an aspect, control point determiner 118 may determine control points from a portion of candidate control points corresponding to copy-resilient image features as determined using copy-resilient image feature determiner 116.

In an aspect, control point determiner 118 determines control points by selecting control points from candidate control points. In an aspect, the selection is random, although other selection methodologies may be employed. A different set of control points may be selected for each warped image to be generated. In an aspect, the number of sets of control points is determined based on the number of warped images to be generated, such as the number of recipients of warped images. Thus, for each intended recipient of a warped image, control point determiner 118 may randomly select a set of control points that is different from a set of control points for another recipient. In an aspect, the number of control points within each determined set is the same. For instance, each set could include five control points. In another aspect, the number of control points for each set is not constant. For example, one set of control points may have five control points, while another set may have six. Other sets may have five, six, or a different number of control points.

In aspects, control point determiner 118 removes some candidate control points before determining the control points for warping images, i.e., the group of candidate control points from which the control points are determined does not include a selection of candidate control points. A select portion of the candidate control points may be removed from consideration as control points based on the location of the candidate control points relative to one or more of a selected input of an image area, text within the images, a standard geometric shape within the images, or another method of identifying an image area. In the example encoder 110, control point determiner 118 may use selection identifier 122, text identifier 124, or geometric shape identifier 126 when determining sets of control points for image warping from candidate control points.

For instance, control point determiner 118 may determine control points for image warping by removing candidate control points as potential control points based on a selection input. In this way, a user can indicate an area within an image that it does not want to be warped. Selection identifier 122 may be used to identify a selected area from a received user input. For example, an input may include a selection of an area within an image provided by the user. The input may include boundaries of the selected area, thus indicating an area within the image that is to be held constant during the warping. Control point determiner 118 may identify candidate control points located within the area identified by the selection. These candidate control points may be removed as options when control point determiner 118 determines sets of control points for warping images.

In another aspect, control point determiner 118 may determine control points for image warping by removing candidate control points as potential control points based on text in the images. As the human eye is particularly adept at seeing changes to text, warping images within warping text of the images helps visually obscure the changes made when warping. Thus, text identifier 124 may identify candidate control points at locations corresponding to text and remove them. To do so, OCR (optical character recognition) model 140 may be employed to identify text within an image. Standard OCR models may be used. Having identified the location of the text, control point determiner 118 may identify candidate control points located within the area corresponding to the text. These candidate control points may be removed as options when control point determiner 118 determines control points for warping images.

In another aspect, control point determiner 118 may determine a set of control points for image warping by removing candidate control points as potential control points based on a standard geometric shape within the image. Generally, a standard geometrical shape is an object that possesses specific, invariant properties that have a mathematical definition. Standard geometric shapes within an image can be one or two dimensions, and are characterized by quantifiable attributes such as length, angle, and area. One-dimensional standard geometrical shapes include straight lines, which are the shortest distance between two points within an image. Two-dimensional standard geometrical shapes include polygons, such as squares, rectangles, and triangles, that are defined by a finite number of straight-line segments connected to form a closed figure, along with circles, which are defined by all points equidistant from a central point. Like text, the human eye is typically able to identify small changes in standard geometric shapes, such as blocks forming a table in the image. As such, it may be beneficial to hold such shapes constant when generating the warped image.

Geometric shape identifier 126 may employ geometric shape model 142 to identify a standard geometric shape within an image. Geometric shape model 142 may comprise one or more models or algorithms for identifying standard geometric shapes. For instance, a Hough transform-based algorithm may be used for identifying some standard geometric shapes, such as straight lines and circles located within the image. Other algorithms for detecting polygons may include Canny edge detection. This may be coupled with shape analysis, such as determining a number of vertices based on the edge detection, to identify a standard geometric shape and its location with the image. Machine leaning methods and other object detection techniques may be used. For instance, CNNs may be trained for general shape detection and used to identify locations of standard geometric shapes within images.

Having identified a standard geometric shape, control point determiner 118 may identify candidate control points located within the area corresponding to the standard geometric shape. These candidate control points may be removed as options when control point determiner 118 determines sets of control points for warping images. In an aspect, candidate control points may have a position corresponding to a position of an edge of a standard geometric shape, such as candidate control points corresponding to a point on a line or another point on an edge of another standard geometric shape. In such cases, the candidate control points corresponding to the edge of a standard geometric shape may be removed for consideration as control points for warping images. As an example, this may be done to keep lines appearing straight in the warped images, helping to create a warped image with less visible modifications.

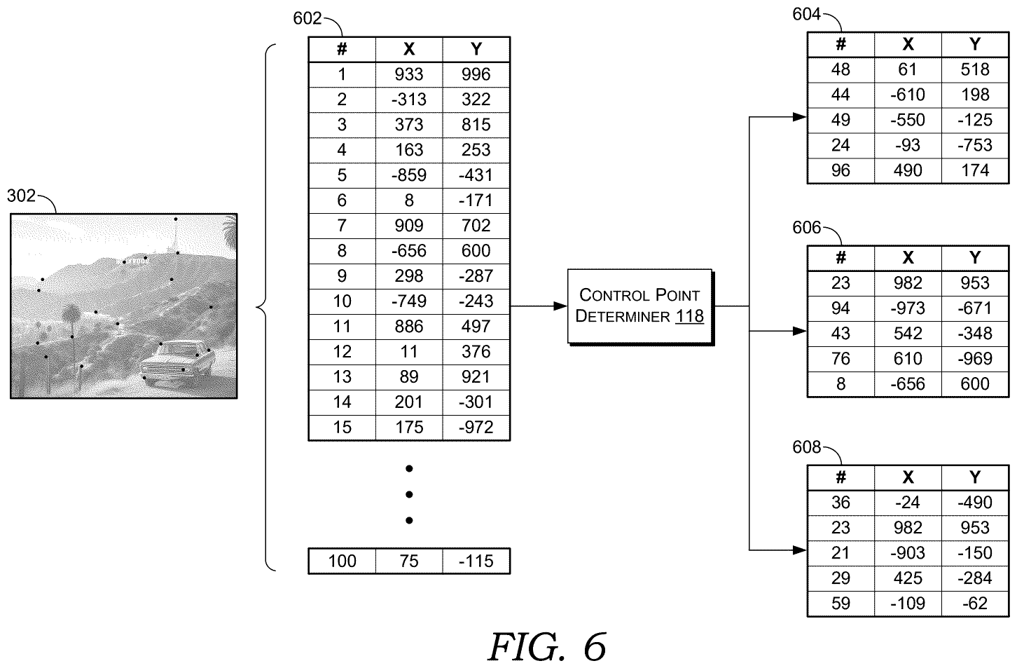

FIG. 6 illustrates an example in which control point determiner 118 is used to determine sets of control points usable for warping images. In the illustration, image 302 is annotated with candidate control points corresponding to image features. In a particular aspect, the candidate control points correspond to copy-resilient image features.

Table 602 of FIG. 6 provides locations for the candidate control points of image 302. That is, each candidate control point may be provided with a relative location within the image. The example used here is an x-y coordinate system and defines each candidate control point in terms of its x-y coordinate position. In a particular aspect, the candidate control points of table 602 include candidate coordinate points having a selection of candidate coordination points removed for an identified area, such as a selection, text, or standard geometric shape.

Control point determiner 118 determines a set of control points by selecting candidate control points from table 602. In an aspect, control point determiner 118 selects a random set of control points from the candidate control points of table 602. Control point determiner 118 may determine the set of control points using another selection methodology to select from candidate control points. In the example illustrated, control point determiner 118 selects three different sets of control points, which may be used to generate three distinct warped images that can be used for source detection. Each set of control points comprises different control points. As shown, control point determiner 118 determines a first set of control points shown in table 604, a second set of control points shown in table 606, and a third set of control points shown in table 608 for use in generating distinct warped images, as will be described. Any number of sets of control points may be generated using control point determiner 118 to generate any number of warped images.

Image warping engine 120 generally structurally warps an image using a set of control points to generate a warped image. Image warping engine 120 may modify pixels of an image based on the pixel's relative location to one or more control points. Pixels may be modified by changing color, intensity, transparency, or other like property. In an aspect, a pixel closer to a control point may be modified to a greater degree than a pixel relatively farther than a pixel farther from the same control point. In doing so, the image may be dilated or contracted according to the control points, pixels closer to control points are dilated or contracted to a greater degree than pixels relatively farther from control points. A decay function may be used so that pixels farther from a control point are modified to a lesser degree than pixels closer to the same control point, with respect to that particular control point. Said differently, image warping engine 120 may warp the image by adjusting properties of pixels based on proximity to a control point, where pixels closer to control points are adjusted to a greater degree than pixels farther from control points.

As noted, a select portion of an image may be held constant during warping, such as an area of the image identified from a selection input, as corresponding to text, or as corresponding to a standard geometric shape, such as a line, polygon, or circle. As such, pixels in a selected portion of the image may not be modified by image warping engine 120 when warping the image. In an aspect, a mask is applied to the selected portion of the image, and the pixels within the mask are not modified by image warping engine 120 when warping the image.

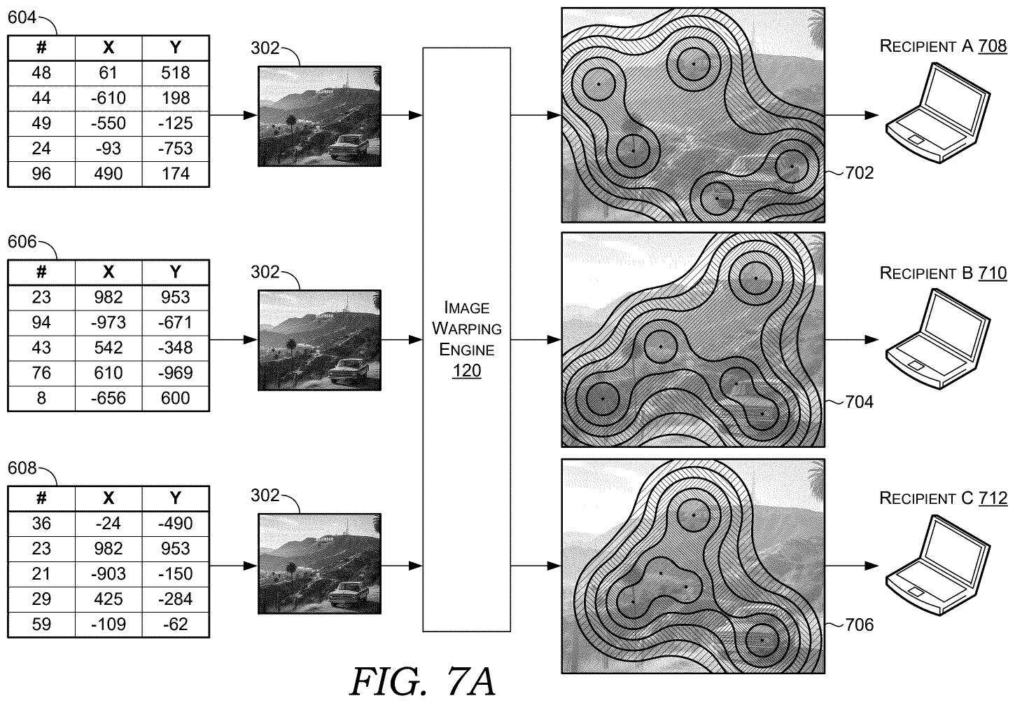

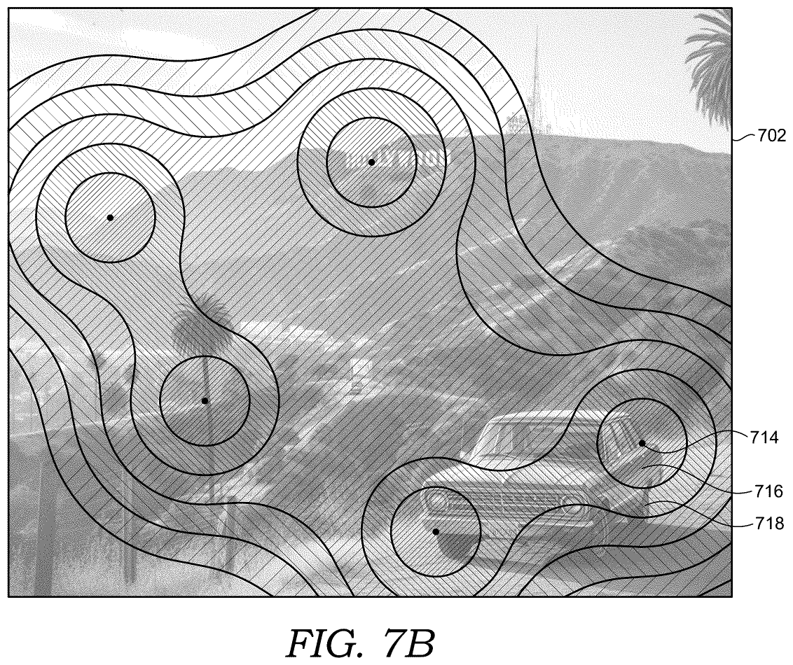

As shown in FIG. 7A, image warping engine 120 may generate warped images from sets of control points. Each different set of control points is used to generate a warped image that is distinct from other warped images. In the illustration, the set of control points from FIG. 6 are used to generate distinct warped images from image 302. As illustrated, image warping engine 120 generates warped image A 702 from image 302 using the set of control points provided by table 604. Image warping engine 120 generates warped image B 704 from image 302 using the set of control points provided by table 606. Image warping engine 120 generates warped image C 706 from image 302 using the set of control points provided by table 608.

FIG. 7B is illustrative of a warped image that may be generated by image warping engine 120. Here, based on control point 714, pixel 716 is modified to a greater degree relative to pixel 718 based on pixel 716 being in closer proximity to control point 714 relative to pixel 718. While warped image A 702 illustrates regions of pixels, it will be understood that pixels may be continuously modified according to proximity to one or more control points, such that each adjacent pixel is modified to a different degree. This may be done to smooth out the modifications across the image, making it more difficult to visually detect the modifications.

Each distinct warped image may be provided to a different recipient. As shown, warped image A 702 is provided to recipient A 708. Warped image B 704 is provided to recipient B 710. Warped image C 706 is provided to recipient C 712. In aspects, a warped image may be provided to a client device for a recipient. The warped image may be provided to a client computing device of a recipient via an electronic address, such as an e-mail address, shared file location, file transfer protocol (FTP) address, an HTTP (hypertext transfer protocol) or other communication protocol, or other like communication address.

Each set of candidate control points can be mapped to a recipient identifier in the source index, such as source index 138 of FIG. 1. A recipient identifier may be any string of characters, including letters, number, and symbols that is representative of, and can be used to identify, a recipient, such as a person or electronic address. Thus, source index 138 may include the set of control points used to generate a warped image mapped to a recipient identifier for the recipient that was provided the warped image.

If an artifact is recovered, the artifact may be compared to warped images to determine the warped image from which it was derived. An artifact is any production derived from a warped image, whether in whole or in part, regardless of the process or method used to derive or obtain it. For instance, an artifact may be derived from a warped image where the artifact is a recovery of the actual warped image after the warped image has been distributed beyond its initial intended recipient. An artifact may be derived from a warped image where the artifact comprises a whole or partial reproduction of the warped image. An artifact may be a digital or electronic production of a warped image. For instance, an artifact may be a digital or physical photograph, including a screenshot or photograph taken with a camera, of the warped image. Another example includes a physical photocopy of a warped image, such as one printed on paper or other physical medium. A potential source of an artifact might be identified as the original recipient of a warped image from which the artifact is derived.

The identified warped image may be used to determine the recipient of the warped image and thus determine a possible source of the artifact. In general, decoder 112 may be used to determine a source of an artifact based on comparing the artifact to one or more warped copies. The example decoder 112 of operating environment 100 includes image warping engine 128, keypoint identifier 130, matching keypoint determiner 132, and source image determiner 134 that can be used to determine whether an artifact matches a warped image, thus identifying the potential source as the recipient of the matching warped image.

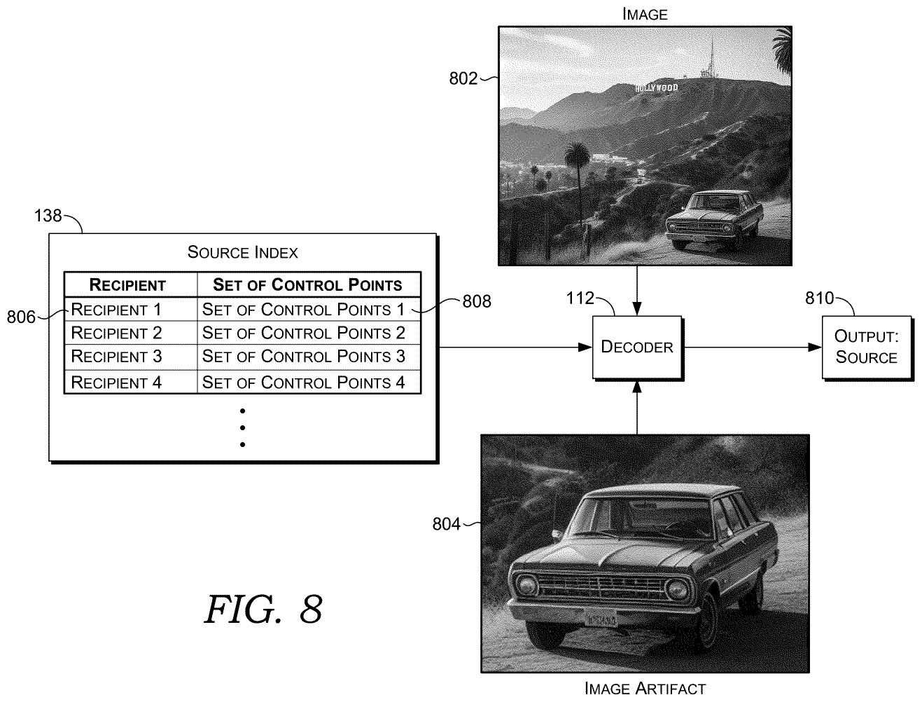

FIG. 8 illustrates an example in which decoder 112 is used to determine the source of an artifact by matching image 802 with image artifact 804. Here, image artifact 804 is recovered and is provided to decoder 112. Image 802 may be determined based on image artifact 804 and may be an original image from which a warped image was generated, where the image artifact 804 was derived from the warped image. In this example, decoder 112 accesses source index 138, which includes a recipient identifier mapped to sets of control points. In the illustration, a recipient identifier is depicted as first recipient 806 and is mapped to a first set of control points 808. One or more of the sets of control points are used to warp one or more images from image 802, respectively. The warped images are compared to image artifact 804 to determine a warped image that matches image artifact 804. Upon identifying the matching warped image, the recipient identifier mapped to the control points that generated the matching warped image may be used to identify the recipient and potential source of image artifact 804, illustrated as source 810.

As noted, when an image artifact is received, the artifact may be compared to warped images to determine whether the artifact matches a warped image. The warped images to which the artifact is compared may be generated from stored sets of control points, as illustrated in FIG. 8, or may be retrieved from previously stored warped images. As noted, there are advantages to saving a mapping of the control points with the recipients because this reduces storage requirements relative to saving existing copies of the warped images. However, each method is contemplated.

To warp images for comparison to an artifact, decoder 112 can employ image warping engine 128. In aspects, image warping engine 128 warps an image using a set of control points retrieved from source index 138. The image warping may be performed in manners similar to those described with respect to image warping engine 120. A same image warping method may be applied by image warping engine 128, and in doing so, image warping engine 128 may generate a warped image that is the same as the warped image previously generated and provided to a recipient. The warped images generated by image warping engine 128 may be used for comparison to the artifact when determining a source of the artifact.

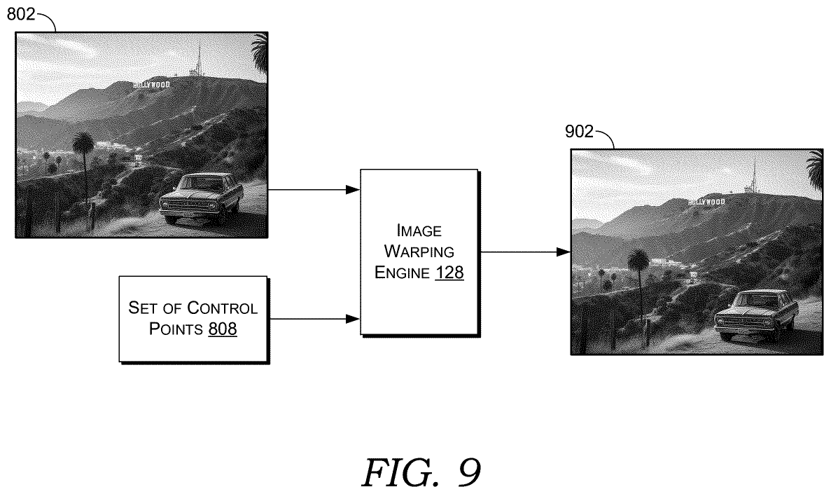

As illustrated in FIG. 9, image warping engine 128 accesses a set of control points 1 808, for example, and warps image 802 using methods previously described to generate warped image 902. While image warping engine 128 is illustrating one warped image, it will be realized that other warped images may be generated from other sets of control points for matching to an artifact and identifying a source.

To match an artifact to a warped image generated by image warping engine 128, or a warped image otherwise retrieved from storage, decoder 112 may employ keypoint identifier 130 and matching keypoint determiner 132 to determine and match keypoints that are used by source image determiner 134 to match the artifact. This is just one example of image matching, and others may be used.

Keypoint identifier 130 generally identifies keypoints within a warped image and an artifact. Keypoints include pixel areas within an image that have an identifiable feature. For instance, this could include edges, where adjacent pixels have different colors or intensities. Other pixel areas identified may include corners or curves, such as those pixel areas having traceable edges forming a geographic shape. These are just examples, and other identifiable features within the pixels may be considered keypoints. In an example, a keypoint identifier 130 may employ the algorithm or a similar algorithm provided by candidate control point model 136 to identify features when identifying candidate control points. Other computer vision algorithms may be used as well that identify features within an image. For instance, a machine learning model, such as a CNN, may be trained on a labeled dataset that includes images tagged to indicate identifiable features, such as corners, edges, or other pixel features. Responsive to the training, the model identifies one or more keypoints from an input image, such as an image artifact or warped image. In an aspect, a SIFT model may be used.

Matching keypoint determiner 132 determines the keypoints that match between keypoints in an artifact and keypoints within a warped image. As an example, a pixel region surrounding each identified keypoint can be represented as a vector in the vector space. The vectors can be compared based on their distance to determine whether a keypoint within the artifact matches a keypoint within a warped image.

In aspects, matching keypoint determiner 132 may apply rigid transformation techniques to aid in comparing and matching the keypoints. The rigid transformation restricts the matching of the keypoints along certain rotations, translations, reflections, or any sequence of the artifact or warped image.

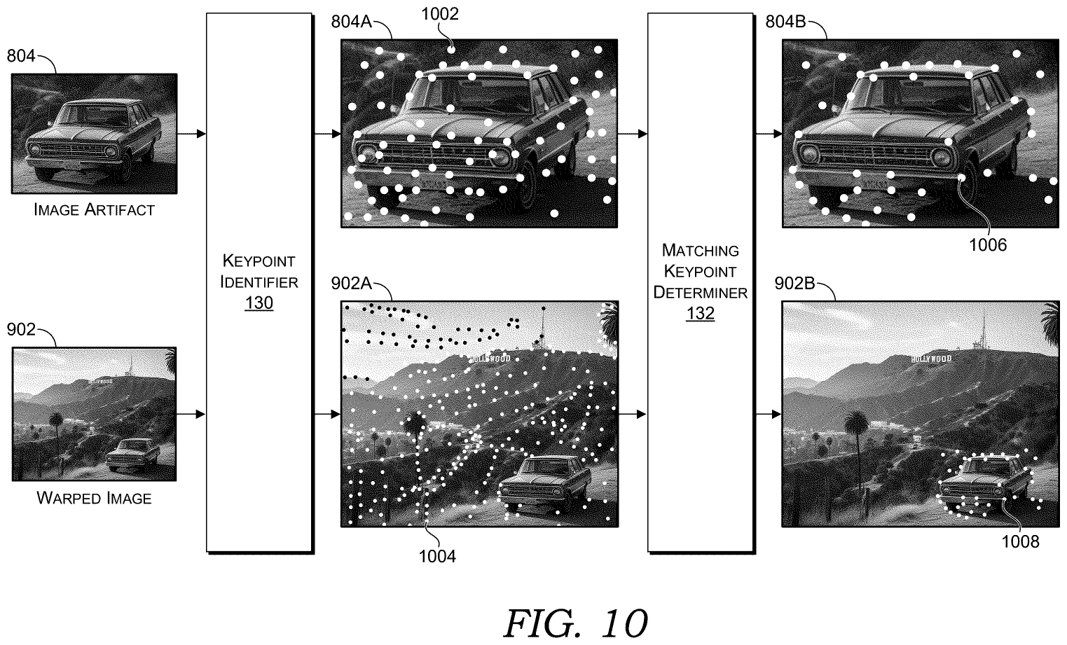

As illustrated in FIG. 10, keypoint identifier 130 may be used to identify keypoints within images, such as an artifact and warped images generated by image warping engine 128. In the illustration, keypoint identifier 130 determines keypoints within image artifact 804. Some example keypoints identified by keypoint identifier 130 are illustrated using annotations, including artifact keypoint 1002 in image artifact 804A. Likewise, keypoint identifier 130 determines keypoints within warped image 902. Some example keypoints are also annotated in warped image 902A as output by keypoint identifier 130, including warped image keypoint 1004.

Matching keypoint determiner 132 is used to determine which artifact keypoints, as illustrated in image artifact 804A, have corresponding matching keypoints within the warped image, illustrated in 902A. Matching keypoints are illustrated using annotations within image artifact 804B and warped image 902B. As an example, artifact keypoint 1006 matches warped image keypoint 1008.

While FIG. 10 illustrates determining keypoints and matching keypoints for one warped image, in some implementations of the technology, keypoints may be determined for a plurality of warped images, in which each warped image is distinct based on a different set of control points used to generate the warped images. As such, image artifact 804 may be compared to one or more of the warped images, as will be described, to determine the warped image matching the artifact.

Some example methods for identifying and matching keypoints is described in U.S. patent application Ser. No. 18/179,635, filed on Mar. 7, 2023, entitled “Information Source Detection Using Unique Watermarks,” which is expressly incorporated herein by reference in its entirety.

Source image determiner 134 generally determines the source based on determining that an artifact at least partially matches a warped image. In aspects, source image determiner 134 may compare an artifact to a plurality of warped images to determine which warped image matches the artifact. In aspects, source image determiner 134 compares an artifact to a warped image based on matching keypoints. For instance, a plurality of warped images may be ranked based on a number of matching keypoints between the warped images and the artifact. In aspects, warped images may be ranked based on the overall fit between matching keypoints (e.g., how closely the matching keypoints match between the artifact and a given warped image). For instance, the closeness of the match could be determined using an average vector distance. In aspects, the matching warped image is determined as the top-ranked warped image. In aspects, a measure of statistical likelihood may be used to identify a matching warped image. For instance, a Pearson correlation or other statistical measurement may be used to determine the likelihood that a warped image matches the artifact relative to other warped images.

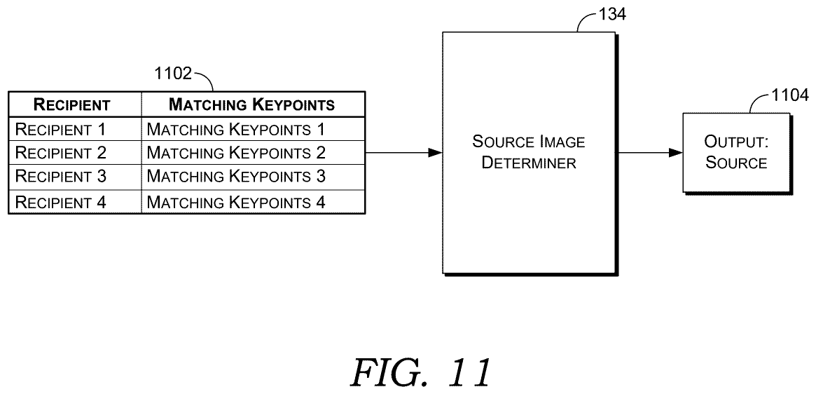

As shown in FIG. 11, source image determiner 134 uses matching keypoints from table 1102 to determine source 1104 for an image artifact. As noted, one or more warped images may be generated for each of a plurality of recipients, such as recipients 1-4 of table 1102. Matching keypoints between the artifact and each warped image can be determined. Source image determiner 134 may apply a measure of statistical likelihood based on the matching keypoints to determine which of the generated warped images is more likely to match the image relative to the other warped images. Source image determiner 134 may output source 1104 as the recipient corresponding to the matching warped image.

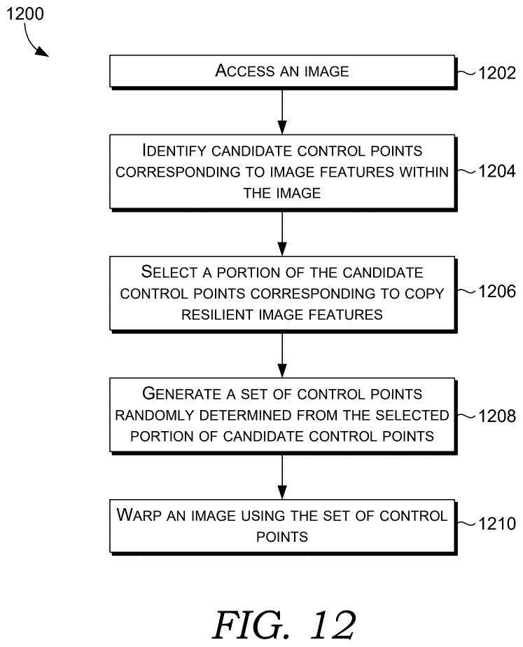

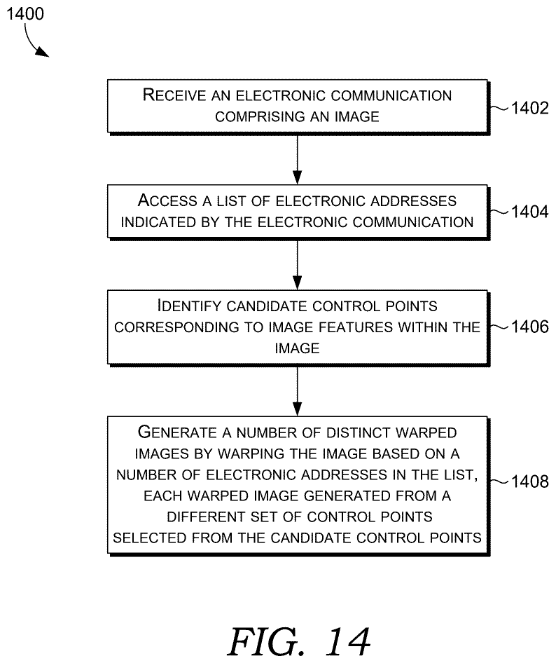

With reference now to FIGS. 12-15, block diagrams are provided respectively illustrating methods 1200-1500. Each block of the methods may comprise a computing process performed using any combination of hardware, firmware, or software. For instance, the methods can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few possibilities. The methods may be implemented in whole or in part by components of operating environment 100.

Referring first to FIG. 12, an example image warping method 1200 for information security is provided. Method 1200 may be performed using encoder 110. In block 1202, an image is accessed. In block 1204, candidate control points corresponding to image features within the image are identified. Candidate control points may be identified using candidate control point identifier 114. Candidate control points may be identified for image features determined within the image.

In block 1206, a portion of the candidate control points corresponding to copy-resilient image features is selected. Copy-resilient image features may be determined using copy-resilient image feature determiner 116. In aspects, copy-resilient image features may be determined, at least in part by blurring one or more images at variable intensities (e.g., 5%, 10%, 20%, or 40% blur) and identifying image features that are visible in the blurred images.

In aspects, copy-resilient image features may be determined, at least in part by determining a pixel neighborhood corresponding to an image feature and determining pixel contrast of the pixels within the pixel neighborhood.

In block 1208, method 1200 generates a set of control points randomly determined from the selected portion of candidate control points. This may be done using control point determiner 118. Any number of control points may be selected and included within a set of control points. In some examples, 5, 10, and 15 control points may be selected; however, other selections may be made. Each set of control points can include at least one different control point than other sets.

When selecting control points from candidate control points, some candidate control points may be removed from consideration. For instance, candidate control points within a select portion of the image may be removed. The selected portion may be based on a selection input identifying an image area, an area corresponding to text, an area corresponding to a standard geometric shape, or another method of identifying a select area of the images.

For instance, a selection of an area within the image may be received. Candidate control points located within the selected area of the image may be removed from consideration as control points for image warping. In an aspect, text within the image is identified, e.g., using an OCR model. Candidate control points located within an area of the image comprising the text may be removed from consideration as control points for image warping. In an aspect, candidate control points located within a standard geometric shape may be removed from consideration as control points for image warping. In some cases, an edge of a standard geometric shape is identified, and candidate control points located at the edge may be removed from consideration as control points for image warping.

In block 1210, method 1200 warps an image using the set of control points. This may be done using image warping engine 120. In aspects, a plurality of warped images is generated, and each warped image is distinct from other warped images based on a respective set of control points used to warp the images. In aspects, pixels closer to control points are warped to a greater degree relative to pixels farther from the control points. In one example, a decay function is used to warp so that pixels closer to control points are adjusted to a greater degree than pixels farther from control points. Pixel intensity, color, transparency, or other pixel features may be modified when warping pixels.

In an aspect, a select portion of the image may be held constant when warping an image. That is, the pixels within the select portion of the image are not modified when generating warped images. In an example, pixels corresponding to a straight line are not modified during the warping. In another example, pixels corresponding to a standard geometric shape are not modified during the warping. In another example, pixels corresponding to text in the image are not modified during the warping. In another example, pixels corresponding to a selection received as an input are not modified during the warping.

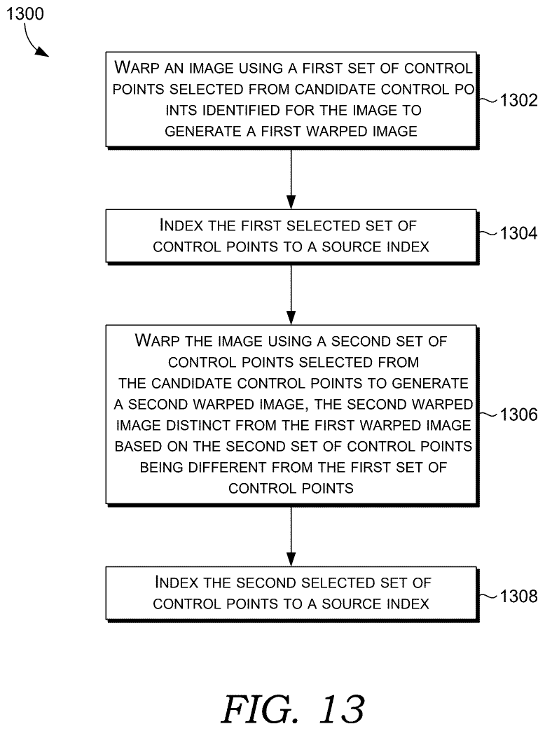

Turning now to FIG. 13, an example image warping method 1300 for information security is provided. Encoder 110 may be used to perform method 1300. In block 1302, method 1300 warps an image using a first set of control points randomly selected from candidate control points identified for the image to generate a first warped image. In an aspect, candidate control point identifier 114 is used to identify the candidate control points. The first set of control points may be determined using copy-resilient image feature determiner 116. The set of control points may be randomly selected using control point determiner 118.

In an aspect, the candidate control points from which the first set of control points is selected correspond to copy-resilient image features, which may be determined using copy-resilient image feature determiner 116.

In block 1304, method 1300 indexes the first randomly selected set of control points to a source index.

In block 1306, method 1300 warps the image using a second set of control points randomly selected from the candidate control points to generate a second warped image, the second warped image distinct from the first warped image based on the second set of control points being different from the first set of control points.

In an aspect, the candidate control points from which the second set of control points is selected correspond to copy-resilient image features, which may be determined using copy-resilient image feature determiner 116.

In an aspect, copy-resilient image features corresponding to the candidate control points from which the first and second sets of control points are selected are identified at least in part based on visibility of the image features within a blurred image. In an aspect, the copy-resilient image features are identified at least in part based on a pixel contrast of pixels in pixel neighborhoods of the image features.

In an aspect, the image warping when generating the first warped image and the second warped image is performed using a decay function that adjusts pixels based on proximity to a control point, where pixels closer to control points are adjusted to a greater degree than pixels farther from control points. In an aspect, pixels within a select portion of the image are held constant during the warping when generating the first warped image and the second warped image.

The first warped image may be provided to a first recipient. The second warped image may be provided a different second recipient. The first warped image may be distinct from the second warped image based on the first set of control points having different control points than the second set of control points.

In block 1308, method 1300 indexes the second randomly selected set of control points to a source index.

When indexing, the first randomly selected set of control points may be mapped to a first recipient identifier for the first recipient. The second randomly selected set of control points may be mapped to a second recipient identifier for the second recipient.

Referring now to FIG. 13, an example image warping method 1400 for information security is provided. Encoder 110 may be used to perform method 1400. In block 1402, method 1400 receives an electronic communication comprising an image. For example, an electronic communication may include an e-mail communication, API (application programming interface) call, web-server communication, or other like communication method. In block 1404, method 1400 accesses a list of electronic addresses indicated by the electronic communication.

In block 1406, method 1400 identifies candidate control points corresponding to image features within the image. Candidate control points may be identified using candidate control point identifier 114.

In an aspect, a set of control points may be selected from the candidate control points for each electronic address. In an aspect, the selection may be made from candidate control points corresponding to copy-resilient image features. Copy-resilient image features may be determined using copy-resilient image feature determiner 116. For instance, a blurred image or a pixel contrast may be used to determine copy-resilient image features. Control point determiner 118 may be used to determine the sets of control points.

In an aspect, the sets of control points are respectively mapped to the electronic addresses within a source index.

In block 1408, method 1400 generates a number of distinct warped images by warping the image based on a number of electronic addresses in the list. Each warped image is generated from a different set of control points randomly selected from the candidate control points. The images may be warped using image warping engine 120.

In an aspect, each of the warped images may be respectively distributed to each of the electronic addresses so that a different warped image is distributed to each electronic address.

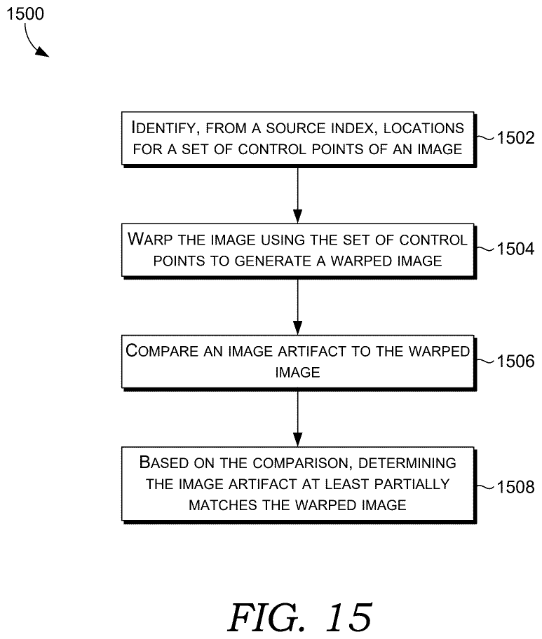

Turning now to FIG. 15, a block diagram of an example method 1500 for matching an artifact to a warped image for source identification is provided. Decoder 112 may be used to perform method 1500.

In block 1502, method 1500 identifies, from a source index, locations for a set of control points of an image. In an aspect, locations for a plurality of sets of control points are identified from the source index.

In block 1504, method 1500 warps the image using the set of control points to generate a warped image. Image warping engine 128 may be used to warp the image. In an aspect, a plurality of distinct warped images is generated using the plurality of sets of control points.

In block 1506, method 1500 compares an image artifact to the warped image. In aspects, the image artifact may be compared to the plurality of distinct warped images. The comparison may be made by generating keypoints within the artifact and keypoints within one or more of the distinct warped images. This may be done using keypoint identifier 130. Matching keypoints can be determined using matching keypoint determiner 132, and the matching keypoints can be used for the comparison. Source image determiner 134 may be used to compare the image artifact and one or more of the distinct warped images using the matching keypoints.

In block 1508, method 1500, based on the comparison, determines that the image artifact at least partially matches the warped image. Source image determiner 134 is used to determine whether the image artifact matches the warped image. A measure of statistical likelihood that the image artifact matches the warped image may be used based on the matching keypoints. This may include a Pearson correlation to determine which of the distinct warped images most likely matches the artifact.

In an aspect, the matching warped image is used to determine a source of the artifact. The set of control points used to generate the warped image may be mapped, within the source index, to a recipient identifier. The recipient identifier may be accessed to determine the recipient corresponding to the recipient identifier, and the recipient may be output as the source.

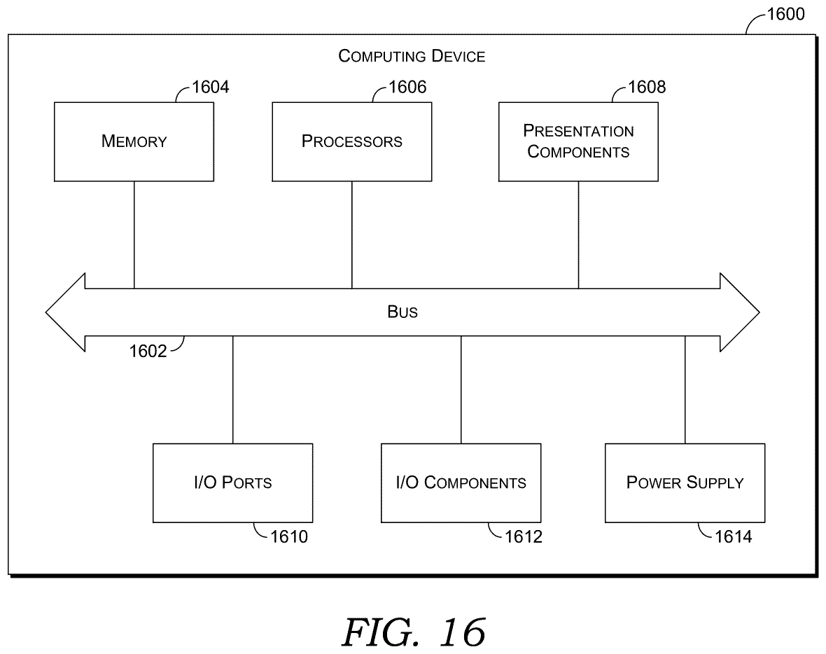

Having described an overview of some embodiments of the present technology, an example computing environment in which embodiments of the present technology may be implemented is described below in order to provide a general context for various aspects of the present technology. Referring now to FIG. 16 in particular, an example operating environment for implementing embodiments of the present technology is shown and designated generally as computing device 1600. Computing device 1600 is but one example of a suitable computing environment and is not intended to suggest any limitation as to the scope of use or functionality of the technology. Computing device 1600 should not be interpreted as having any dependency or requirement relating to any one or combination of components illustrated.

The technology may be described in the general context of computer code or machine-useable instructions, including computer-executable instructions, such as program modules, being executed by a computer or other machine, such as a cellular telephone, personal data assistant, or other handheld device. Generally, program modules, including routines, programs, objects, components, data structures, etc., refer to code that performs particular tasks or implements particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

With reference to FIG. 16, computing device 1600 includes bus 1602, which directly or indirectly couples the following devices: memory 1604, one or more processors 1606, one or more presentation components 1608, input/output (I/O) ports 1610, input/output components 1612, and illustrative power supply 1614. Bus 1602 represents what may be one or more buses (such as an address bus, data bus, or combination thereof). Although the various blocks of FIG. 16 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventors recognize that such is the nature of the art, and reiterate that the diagram of FIG. 16 is merely illustrative of an example computing device that can be used in connection with one or more embodiments of the present technology. Distinction is not made between such categories as “workstation,” “server,” “laptop,” “handheld device,” etc., as all are contemplated within the scope of FIG. 16 and with reference to “computing device.”

Computing device 1600 typically includes a variety of computer-readable media. Computer-readable media can be any available media that can be accessed by computing device 1600 and includes both volatile and non-volatile media, and removable and non-removable media. By way of example, and not limitation, computer-readable media may comprise computer storage media and communication media. Computer storage media, also referred to as a communication component, includes both volatile and non-volatile, removable and non-removable media implemented in any method or technology for storage of information, such as computer-readable instructions, data structures, program modules, or other data. Computer storage media includes, but is not limited to, RAM, ROM, EEPROM, flash memory, or other memory technology; CD-ROM, digital versatile disks (DVDs), or other optical disk storage; magnetic cassettes, magnetic tape, magnetic disk storage, or other magnetic storage devices; or any other medium that can be used to store the desired information and that can be accessed by computing device 1600. Computer storage media does not comprise signals per se.

Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 1604 includes computer storage media in the form of volatile or non-volatile memory. The memory may be removable, non-removable, or a combination thereof. Example hardware devices include solid-state memory, hard drives, optical-disc drives, etc. Computing device 1600 includes one or more processors that read data from various entities, such as memory 1604 or I/O components 1612. Presentation component(s) 1608 presents data indications to a user or other device. Example presentation components include a display device, speaker, printing component, vibrating component, etc.

I/O ports 1610 allow computing device 1600 to be logically coupled to other devices, including I/O components 1612, some of which may be built-in. Illustrative components include a microphone, joystick, game pad, satellite dish, scanner, printer, wireless device, etc. The I/O components 1612 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition, both on screen and adjacent to the screen, as well as air gestures, head and eye tracking, or touch recognition associated with a display of computing device 1600. Computing device 1600 may be equipped with depth cameras, such as stereoscopic camera systems, infrared camera systems, RGB (red-green-blue) camera systems, touchscreen technology, other like systems, or combinations of these, for gesture detection and recognition. Additionally, the computing device 1600 may be equipped with accelerometers or gyroscopes that enable detection of motion. The output of the accelerometers or gyroscopes may be provided to the display of computing device 1600 to render immersive augmented reality or virtual reality.

At a low level, hardware processors execute instructions selected from a machine language (also referred to as machine code or native) instruction set for a given processor. The processor recognizes the native instructions and performs corresponding low-level functions relating, for example, to logic, control, and memory operations. Low-level software written in machine code can provide more complex functionality to higher levels of software. As used herein, computer-executable instructions includes any software, including low-level software written in machine code; higher-level software, such as application software; and any combination thereof. Any other variations and combinations thereof are contemplated within embodiments of the present technology.

With reference back to FIG. 1, an example operating environment 100 in which aspects of the technology may be employed is provided. Among other components or engines not shown, operating environment 100 comprises server 102, client device 104, and database 106, which communicate via network 108.

Generally, server 102 is a computing device that implements functional aspects of operating environment 100, such as one or more functions of encoder 110 and decoder 112 for information embedding and source detection. One suitable example of a computing device that can be employed as server 102 is described as computing device 1600 with respect to FIG. 16.

Client device 104 is generally a computing device, such as computing device 1600 of FIG. 16. Client device 104 may perform various functions, such as image warping and source detection. In aspects, client device 104 may perform functions described with respect to encoder 110 and decoder 112.

As with other components of FIG. 1, server 102 and client device 104 are each intended to represent one or more devices. In implementations, client device 104 is a client-side or front-end device, and server 102 represents a back-end or server-side device. It will be understood that some implementations of the technology will comprise either a client-side or front-end computing device, a back-end or server-side computing device, or both, executing any combination of functions for warping images and information source detection. FIG. 1 is simply one example illustration of a computing environment in which the technology may be employed, although it will be recognized that other arrangements of devices and functions may be used with the technology as well. All are intended to be within the scope of the present disclosure, as will be further noted.

Database 106 generally stores information, including data, computer instructions (e.g., software program instructions, routines, or services), or models used in embodiments of the described technologies. Although depicted as a single database component, database 106 may be embodied as one or more databases or may be in the cloud.

Network 108 may include one or more networks (e.g., public network or virtual private network [VPN]), as shown with network 108. Network 108 may include, without limitation, one or more local area networks (LANs), wide area networks (WANs), or any other communication network or method.

With continued reference to FIG. 1, it is noted and again emphasized that any additional or fewer components, in any arrangement, may be employed to achieve the desired functionality within the scope of the present disclosure. Although the various components of FIG. 1 are shown with lines for the sake of clarity, in reality, delineating various components is not so clear, and metaphorically, the lines may more accurately be grey or fuzzy. Although some components of FIG. 1 are depicted as single components, the depictions are intended as examples in nature and in number and are not to be construed as limiting for all implementations of the present disclosure. The functionality of operating environment 100 can be further described based on the functionality and features of its components. Other arrangements and elements (e.g., machines, interfaces, functions, orders, and groupings of functions, etc.) can be used in addition to or instead of those shown, and some elements may be omitted altogether.

Further, some of the elements described in relation to FIG. 1, such as those described in relation to encoder 110 and decoder 112, are functional entities that may be implemented as discrete or distributed components or in conjunction with other components, and in any suitable combination and location. Various functions described herein are being performed by one or more entities and may be carried out by hardware, firmware, or software. For instance, various functions may be carried out by a processor executing computer-executable instructions stored in memory, such as database 106. Moreover, functions of encoder 110 and decoder 112, among other functions, may be performed by server 102, client device 104, or any other component, in any combination.

Referring to the drawings and description in general, having identified various components in the present disclosure, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, or software. For instance, various functions may be carried out by a processor executing instructions stored in memory. As such, other arrangements and elements (e.g., machines, interfaces, functions, orders, and groupings of functions, etc.) can be used in addition to or instead of those shown.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the words “including,” “having,” and other like words and their derivatives have the same broad meaning as the word “comprising,” and the word “accessing” comprises “receiving,” “referencing,” or “retrieving,” or derivatives thereof. Further, the word “communicating” has the same broad meaning as the word “receiving” or “transmitting,” as facilitated by software or hardware-based buses, receivers, or transmitters using communication media described herein.

In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

As further used herein, the term “train,” when referring to training a machine learning model, may mean training an untrained model, further training a previously trained model, fine-tuning a pre-trained model, or the like. “Train” is intended to broadly cover methods of machine learning using a dataset.

For purposes of a detailed discussion above, embodiments of the present technology are described with reference to a distributed computing environment. However, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the schematics described herein, it is understood that the techniques described may be extended to other implementation contexts.

From the foregoing, it will be seen that this technology is one well-adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated by the accompanying drawings is to be interpreted as illustrative and not in a limiting sense.

Some example aspects that can be practiced from the foregoing description include the following:

Aspect 1: A computer-implemented method of image warping for information security, the method comprising: accessing an image; identifying candidate control points corresponding to image features within the image; selecting a portion of the candidate control points corresponding to copy-resilient image features; generating a set of control points determined from the selected portion of candidate control points; and warping an image using the set of control points.

Aspect 2: Aspect 1, further comprising: blurring the image at variable intensities; and identifying the copy-resilient image features based on visibility of the image features within the blurred images.

Aspect 3: Any of Aspects 1-2, further comprising: determining pixel neighborhoods for the image features; and identifying the copy-resilient image features based on a pixel contrast of pixels in the pixel neighborhoods.

Aspect 4: Any of Aspects 1-3, further comprising: receiving a selection of an area within the image; and removing candidate control points located within the selected area of the image.

Aspect 5: Any of Aspects 1-4, further comprising: identifying text within the image; and removing candidate control points located within an area of the image comprising the text.

Aspect 6: Any of Aspects 1-5, further comprising: identifying an edge of a standard geometric shape within the image; and removing candidate control points corresponding to the edge of the standard geometric shape.

Aspect 7: Any of Aspects 1-6, wherein: warping the image is performed using a decay function that adjusts pixels based on proximity to a control point, where pixels closer to control points are adjusted to a greater degree than pixels farther from control points; and pixels within a select portion of the image are held constant during the warping.

Aspect 8: One or more computer storage media storing computer-readable instructions thereon that, when executed by a processor, cause the processor to perform a method of image warping for information security, the method comprising: warping an image using a first set of control points selected from candidate control points identified for the image to generate a first warped image; indexing the first selected set of control points to a source index; warping the image using a second set of control points selected from the candidate control points to generate a second warped image, the second warped image distinct from the first warped image based on the second set of control points being different from the first set of control points; and indexing the second selected set of control points to a source index.

Aspect 9: Aspect 8, further comprising: providing the first warped image to a first recipient; and providing the second warped image to a different second recipient.

Aspect 10: Any of Aspects 8-9, further comprising: mapping the first selected set of control points to a first recipient identifier in the source index; and mapping the second selected set of control points to a second recipient identifier in the source index.

Aspect 11: Any of Aspects 8-10, further comprising: identifying candidate control points corresponding to image features within the image; and selecting a portion of the candidate control points corresponding to copy-resilient image features, wherein the first set of control points and the second set of control points are each selected from the selected portion of candidate control points corresponding to the copy-resilient image features.

Aspect 12: Aspect 11, further comprising identifying the copy-resilient image features based on visibility of the image features within a blurred image.

Aspect 13: Any of Aspects 11-12, further comprising identifying the copy-resilient image features based on a pixel contrast of pixels in pixel neighborhoods of the image features.

Aspect 14: Any of Aspects 8-13, wherein: warping the image, using the first set of control points and the second set of control points, is performed using a decay function that adjusts pixels based on proximity to a control point, where pixels closer to control points are adjusted to a greater degree than pixels farther from control points; and pixels within a select portion of the image are held constant during the warping.

Aspect 15: A system for warping an image for information security, the system comprising: at least one processor; and one or more computer storage media storing computer-readable instructions thereon that, when executed by the at least one processor, cause the at least one processor to perform operations comprising: receiving an electronic communication comprising an image; accessing a list of electronic addresses indicated by the electronic communication; identifying candidate control points corresponding to image features within the image; and generating a number of distinct warped images by warping the image based on a number of electronic addresses in the list, each warped image generated from a different set of control points selected from the candidate control points.

Aspect 16: Aspect 15, wherein the operations further comprise respectively distributing each of the warped images to each of the electronic addresses, such that a different warped image is distributed to each electronic address.

Aspect 17: Any of Aspects 15-16, wherein the operations further comprise indexing, to a source index, each of the electronic addresses mapped to a set of control points used to generate a warped image provided to the electronic address.

Aspect 18: Any of Aspects 15-17, wherein the operations further comprise selecting a portion of the candidate control points corresponding to copy-resilient image features, wherein each different set of control points is each selected from the selected portion of candidate control points corresponding to the copy-resilient image features.

Aspect 19: Aspect 18, wherein the operations further comprise identifying the copy-resilient image features based on visibility of the image features within a blurred image.

Aspect 20: Any of Aspects 18-19, wherein the operations further comprise identifying the copy-resilient image features based on a pixel contrast of pixels in pixel neighborhoods of the image features.

Aspect 21: A computer-implemented method for determining an artifact source, the method comprising: identifying, from a source index, locations for a set of control points of an image; warping the image using the set of control points to generate a warped image; comparing an image artifact to the warped image; and based on the comparison, determining the image artifact at least partially matches the warped image.

Aspect 22: Aspect 21, further comprising retrieving, from the source index, a source that is mapped to the locations for the set of control points.

Aspect 23: Any of Aspects 21-22, further comprising: identifying, from the source index, locations for a plurality of sets of control points; warping the image using each set of control points to generate a plurality of distinct warped images; and further comparing the image artifact to each of the distinct warped images, wherein determining the image artifact at least partially matches the warped image comprises using a measure of statistical likelihood that indicates that the image artifact more likely matches the warped image relative to the distinct warped images of the plurality.

Aspect 24: Aspect 23, wherein the measure of statistical likelihood uses a Pearson correlation.

Aspect 25: Any of Aspects 21-24, wherein the image artifact is a photograph of the image.

Aspect 26: Any of Aspects 21-24, wherein the image artifact is a photocopy of the image.

Aspect 27: Any of Aspects 21-22 and 24-26, further comprising: generating keypoints within the artifact; generating keypoints within the warped image; and determining matching keypoints from the keypoints within the artifact and the keypoints within the warped image, wherein the image artifact is determined to at least partially match the warped image based on a measure of statistical likelihood that uses the matching keypoints.

What is claimed is:

1. A computer-implemented method of image warping for information security, the method comprising:
accessing an image;
identifying candidate control points corresponding to image features within the image;
selecting a portion of the candidate control points corresponding to copy-resilient image features;
generating a set of control points randomly determined from the selected portion of candidate control points; and
warping the image using the set of control points.

2. The computer-implemented method of claim 1, further comprising:
blurring the image at variable intensities; and
identifying the copy-resilient image features based on visibility of the image features within the blurred images.

3. The computer-implemented method of claim 1, further comprising:
determining pixel neighborhoods for the image features; and
identifying the copy-resilient image features based on a pixel contrast of pixels in the pixel neighborhoods.

4. The computer-implemented method of claim 1, further comprising:
receiving a selection of an area within the image; and
removing candidate control points located within the selected area of the image.

5. The computer-implemented method of claim 1, further comprising:
identifying text within the image; and
removing candidate control points located within an area of the image comprising the text.

6. The computer-implemented method of claim 1, further comprising:
identifying an edge of a standard geometric shape within the image; and
removing candidate control points corresponding to the edge of the standard geometric shape.

7. The computer-implemented method of claim 1, wherein:
warping the image is performed using a decay function that adjusts pixels based on proximity to a control point, where pixels closer to control points are adjusted to a greater degree than pixels farther from control points; and
pixels within a select portion of the image are held constant during the warping.

8. One or more computer storage media storing computer-readable instructions thereon that, when executed by a processor, cause the processor to perform a method of image warping for information security, the method comprising:
warping an image using a first set of control points selected from candidate control points identified for the image to generate a first warped image;
indexing the first selected set of control points to a source index;
warping the image using a second set of control points selected from the candidate control points to generate a second warped image, the second warped image being distinct from the first warped image based on the second set of control points being different from the first set of control points; and
indexing the second selected set of control points to a source index.

9. The media of claim 8, further comprising:
providing the first warped image to a first recipient; and
providing the second warped image to a different second recipient.

10. The media of claim 8, further comprising:
mapping the first selected set of control points to a first recipient identifier in the source index; and
mapping the second selected set of control points to a second recipient identifier in the source index.

11. The media of claim 8, further comprising:
identifying candidate control points corresponding to image features within the image; and
selecting a portion of the candidate control points corresponding to copy-resilient image features, wherein the first set of control points and the second set of control points are each selected from the selected portion of candidate control points corresponding to the copy-resilient image features.

12. The media of claim 11, further comprising identifying the copy-resilient image features based on visibility of the image features within a blurred image.

13. The media of claim 11, further comprising identifying the copy-resilient image features based on a pixel contrast of pixels in pixel neighborhoods of the image features.

14. The media of claim 8, wherein:
warping the image, using the first set of control points and the second set of control points, is performed using a decay function that adjusts pixels based on proximity to a control point, where pixels closer to control points are adjusted to a greater degree than pixels farther from control points; and
pixels within a select portion of the image are held constant during the warping.

15. A system for warping an image for information security, the system comprising:
at least one processor; and
one or more computer storage media storing computer-readable instructions thereon that, when executed by the at least one processor, cause the at least one processor to perform operations comprising:
receiving an electronic communication comprising an image;
accessing a list of electronic addresses indicated by the electronic communication;
identifying candidate control points corresponding to image features within the image; and
generating a number of distinct warped images by warping the image based on a number of electronic addresses in the list, each warped image generated from a different set of control points selected from the candidate control points.

16. The system of claim 15, wherein the operations further comprise respectively distributing each of the warped images to each of the electronic addresses, such that a different warped image is distributed to each electronic address.

17. The system of claim 15, wherein the operations further comprise indexing, to a source index, each of the electronic addresses mapped to a set of control points used to generate a warped image provided to an electronic address.

18. The system of claim 15, wherein the operations further comprise selecting a portion of the candidate control points corresponding to copy-resilient image features, wherein each different set of control points is each selected from the selected portion of candidate control points corresponding to the copy-resilient image features.

19. The system of claim 18, wherein the operations further comprise identifying the copy-resilient image features based on visibility of the image features within a blurred image.

20. The system of claim 18, wherein the operations further comprise identifying the copy-resilient image features based on a pixel contrast of pixels in pixel neighborhoods of the image features.
